(19) United States
(12) Patent Application Publication
(10) Pub. No.: US 2013/0230840 A1
(43) Pub. Date: Sep. 5, 2013

(54) LEARNING SYSTEM ACCESSORY USING PORTABLE HANDHELD DEVICES

(71) Applicant: DEVENDRA PARKAR, Murphy, TX (US)

(72) Inventor: DEVENDRA PARKAR, Murphy, TX (US)

(21) Appl. No.: 13/412,012

(22) Filed: Mar. 5, 2012

(51) Int. Cl. G09B 5/00

(52) U.S. Cl. 434/322

(57) ABSTRACT

In view of the foregoing, an embodiment herein provides a learning system accessory (herein referred as LSA) which can be integrated with a portable handheld device and use the resultant system as a learning tool for kids. In an embodiment, a keypad including plurality of keys is provided in the LSA. The keys can be divided into a number of categories depending on their function. Further, an “Apps” key is provided to segregate the LSA-supported Apps from the other Apps available on the portable handheld device. The keys in the keypad the can be mapped according to the user's need, such that the pressing of a certain key would launch a specific App. In addition, LED indicators provided on the LSA can be customized to respond in a certain manner, as decided by the learning application running on the portable handheld device.

### TECHNICAL FIELD

The embodiments herein generally relate to a learning system accessory for helping children to access different educational learning tools. Specifically, the embodiments described herein relate to a learning system accessory that can be integrated with a handheld portable device and to a software system for the learning system accessory.

### DESCRIPTION OF THE RELATED ART

In the present market, there are lots of educational products/toys available for children of all ages. Educational toys interact with children and enhance their social, intellectual, emotional and physical development. There are toys to help a child learn about a certain subject or to develop a certain skill.

To encourage a child to develop with the help of these educational toys, most of these toys are segregated with definite age groups. For example, building blocks and puzzles help the pre-school child to understand spatial relationships or an electronic math toy for an elementary school child that help the child develop mathematical skills. However, one disadvantage of such age-specific toys is that these educational toys would help in developing a child's intellect and ability but only for a certain period of time after which the toy becomes redundant. Many of these toy products are self-contained and would integrate a display screen, speakers, keyboard and application programs.

Though age-specific toys are still popular, the focus has now shifted to toys that grow along with the child. For example, video integrated educational toys that come with various age-specific cartridges, such that a pre-school child can learn of the basics of alphabets, an elementary school child can develop his mathematical skills and a post-elementary school child can understand geography better by using the same toy. Many of the earlier educational toys came in a non-upgradeable format; however in recent years, the trend has changed and now toys come with a variety of cartridges for additional programming, for example, the educational laptops available for children. These look like a variant of the real laptops, except they come with limited functionality. They are preloaded with various activities, and cartridges are sold separately if one wants to upgrade the learning system. There are interactive books where a certain cartridge for a certain book is inserted and a child can listen to the book being read. Some also comes with microphones that help record the child's voice and makes it more interactive. Such toys increase the lifetime and playability of the toy. However, each time the toy needs to be upgraded, cartridges need to be purchased. Moreover, for the all-round development of a child, different educational program needs to be purchased, thus making the purchases a lot more expensive.

There are also portable handheld multimedia devices meant for children that come with a variety of educational activities from spelling to science. Some of them provide touch technology and the use of a stylus. However, these portable devices are quite expensive. Though there are various educational products/toys available in the market, some cannot be upgraded, some provides very expensive up-gradation and there are others like the portable handheld multimedia devices which are quite expensive.

On the other hand, portable handheld devices in the form of phones, pods and tablets primarily meant for adults have started gaining popularity among children because of the range of Apps available in them that provides both entertainment and education. One merit of using these Apps is that they are easily downloadable, and they provide a plethora of educational avenues. However, there are disadvantages associated with these portable handheld devices. Since these devices are meant for the adult, they do not come with child-friendly features, for example, a child cannot easily operate on the keys of a portable handheld device. A post elementary school child may understand the functionality of the limited keys available on a portable handheld device but a younger child will not be able to operate the keys on his own and will require constant supervision. Moreover, portable handheld device screens are small and as such when touch screen keyboards appear on the screen, it constricts the screen space further. Also, there is no ease of use for a child when a portable handheld device is coupled with too many interfaces. A child may not be able to access the applications easily or explore the contents.

Even though portable handheld device can have multiple installed Apps, each App typically provides bits and pieces of overall educational needs. That requires the child to be aware of all these installed Apps and switch from one App to another, as needed. That does not provide the complete and planned educational or learning experience that is required from an educational toy or a system. On the other hand, if one decides to combine many educational features into one App, that would also make it one jumbo App that is very big to download, install and run. So there is a need for an external agent outside the individual Apps that can bring homogeneous experience to the user, yet while encapsulating the intrinsic details of navigating across the Apps.

Again, though the portable handheld device has been used for educational purpose, yet a child may not understand the sturdiness of a cell phone and expose it to abuse, or the basic portable handheld device, however appealing to an adult, may not appeal to a child's sensibilities.

Though the problem of application up-gradation suffered by traditional educational toys has been solved by the advent of the portable handheld device as an educational toy, yet the disadvantages are apparent.

In the present scenario, there is a space for a product which is neither a self-contained educational toy nor a portable handheld device meant for adults but which solves the disadvantages suffered by both. It can be a product/accessory which can complement the portable device and make the device easily operable by the children. Such kind of product should complement the portable handheld device and makes it more accessible to children.

There therefore exists a need in the art to provide for a learning system accessory that can be attached/integrated to the portable handheld device such that it not only provides ease-of-accessibility to the child but also appeals to the child. Moreover, a learning accessory is required that comes with keys that makes accessibility easier to a child and by having external keys help in providing better and much-needed visible screen space to the toy.

### OBJECTS OF THE INVENTION

A main object of the present invention is to provide a learning system accessory that can be easily integrated with a portable handheld device so that the instant accessory can be used in conjunction with different educational applications provided in the device.

Another object of the present invention is to provide a software system in the portable handheld device for the learning system accessory to integrate it with the portable handle device.

Yet another object of the present invention is to provide an easy-to-use interface through which a child can easily access the Apps he wants from the plethora of Apps available in a portable handheld device.

Still another object of present invention is to provide seamless interface to the user, while encapsulating the intrinsic details of switching and navigating among many Apps, wherein the keys on LSA are mapped to various content or programming items that is spread across many Apps, and the Apps are switched in the background without user explicitly performing an action of switching the Apps.

Another object of the present invention is to provide easy content exploration of the portable handheld device by using a key mapped list provided in the LSA.

Another object of the present invention is to transform a portable handheld device into a kid's educational toy in an inexpensive manner.

Another object of the present invention is to provide instant help to the child through pressing of a single key that would facilitate bidirectional communication between LSA and portable handheld device, and also allow the child to seek help from their parents or other designated help providers.

Another object of the invention is to protect the portable handheld device by enclosing it in a sturdy enclosure and safe locking the device inside the LSA.

The other objects and advantages of the present invention will be apparent from the following description when read in conjunction with the accompanying drawings which are incorporated for illustration of preferred embodiments of the present invention and are not intended to limit the scope thereof.

### SUMMARY

In view of the foregoing, an embodiment herein provides a learning system accessory (herein referred as LSA) which can be integrated with a portable handheld device for using as a learning tool for kids. In an embodiment, a keypad is provided in the LSA for easier accessibility of the keys, and the keys can be divided into a number of categories depending on their function. In one embodiment, the keypad includes quick access keys, help buttons, answer buttons, alphabet buttons, numerical buttons and mathematical function buttons and navigational buttons. These keys are such that when pressed, the user command is received by the portable handheld device and the command is carried out by suitable compatible software running in the device.

In an embodiment, the LSA includes an “Apps” button [can be referred as key] to segregate the LSA-supported Apps from the other Apps available on the portable handheld device. Accordingly, it enables for easy exploration of learning applications for a child since he does not have to go through all the Apps available on the device and determine which ones are supported by the LSA. At one press of the “Apps” key, all the LSA-supported Apps, either installed or yet to be installed can be displayed in one screen.

In a further embodiment, the keys can be mapped to facilitate easy, quick and pre-configured launch of one or more Apps, such that the pressing of a certain key would launch a specific App.

In a further embodiment, the LSA includes one or more LED indicators which can be customized to respond in a certain manner, as decided by the learning application running on the portable handheld device.

In a further embodiment, the LSA can include one or more speakers or amplification circuit to amplify the sounds.

In a further embodiment, the LSA may include a battery for power supply. In another embodiment, no battery is provided as the LSA is able to derive power from the portable handheld device.

In one embodiment, a software system is provided for integrating LSA with the portable device, wherein the system 300 can include, but is not limited to a core system module, functional specific modules, core mapping list module and shared libraries.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications

### BRIEF DESCRIPTION OF THE DRAWINGS

The detailed description is set forth with reference to the accompanying figures.

In the figures, the left-most digit(s) of a reference number identifies the figure in which the reference number first appears. The use of the same reference numbers in different figures indicates similar or identical items.

FIG. 1 illustrates general view of LSA with its various parts and a portable handheld device integrated with the LSA according to an embodiment herein;

FIG. 2a illustrates suitably optimized keypad provided in LSA for kid's learning according to an embodiment herein;

FIG. 2b illustrates a software system architecture for integrating the LSA with the portable handle held device according to an embodiment herein;

FIG. 3 illustrates portable handheld device screen and problem associated in spotting Apps meant for kids according to conventional device;

FIG. 4 illustrates device screen wherein the Apps meant for kids are only displayed according to an embodiment herein;

FIG. 5 illustrates various steps involved in response to pressing “Apps” key according to an embodiment herein;

FIG. 6 illustrates system response for various user actions on the home key provided in learning system accessory according to an embodiment herein;

FIG. 7a illustrates key mapped list sequence according to an embodiment herein;

FIG. 7b illustrates working principle of remote assistance key according to an embodiment herein;

FIG. 8 illustrates App to App communication via LSA according to an embodiment herein;

FIG. 9a illustrates global score management system of the LSA according to an embodiment herein;

FIG. 9b illustrates global score management system of the LSA according to an embodiment herein;

FIG. 10a illustrates flow chat of working of the LSA coupled with the portable handheld device according to an embodiment herein;

FIG. 10b illustrates flow chat of further working of the LSA coupled with the portable handheld device according to an embodiment herein;

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the present description, the terms “LSA adaptable Apps”, “LSA supported Apps” and “installable LSA supported Apps” are used interchangeably. The terms “handheld device”, “portable handheld device” or “portable device” or ‘electronic handheld device’ or “smart touch device” or simply ‘device’ connotes the same meaning. “Learning System Accessory” is abbreviated to “LSA” or “accessory” and hence connotes the same meaning. “Apps” means application software that runs on the device operating systems. “System command” means a command that can be either send from an accessory to operating systems of a device (OS) and vice versa. “User command” means a command that can be either send from an accessory to the App running on the device and vice versa.

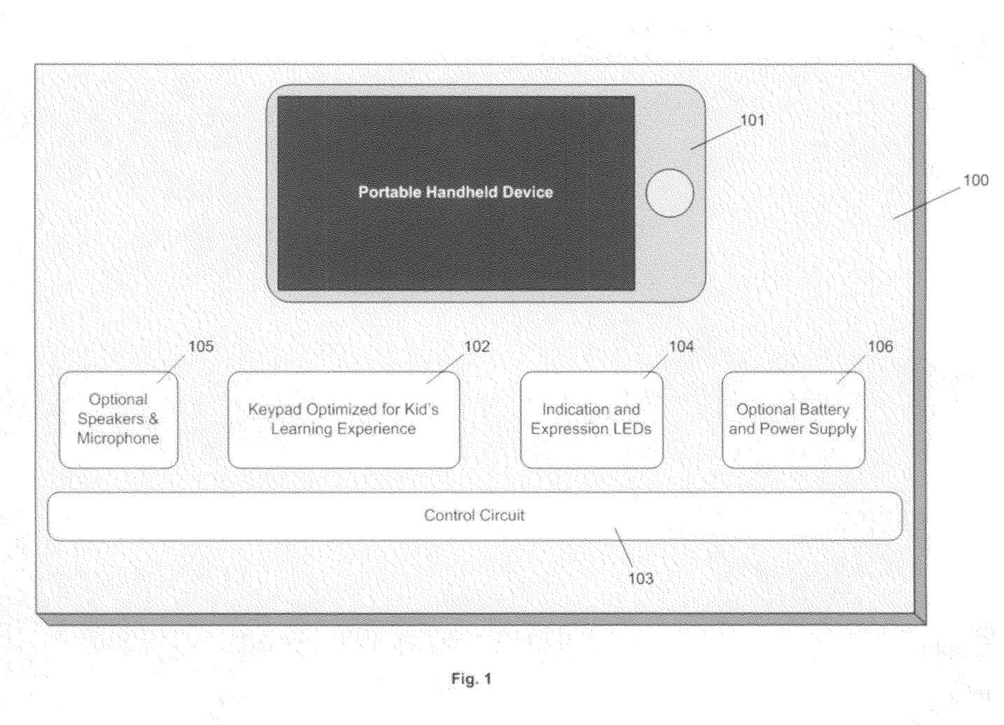

As mentioned, there remains a need for learning system accessory that can be used with portable handheld device that would overcome the disadvantages suffered by traditional learning systems or independent learning Apps provided in a portable handheld device. The embodiments herein achieve this by providing a learning system accessory (LSA) that is integrated with a portable handheld device. Referring now to the drawings to FIGS. 1 through 10, where similar reference characters denote corresponding features consistently throughout the figures, there are shown preferred embodiments.

As illustrated in FIG. 1, the LSA 100 is integrated with a portable handheld device 101, according to an embodiment. The portable handheld device 101 plays primary role in application level intelligence that is instrumental for one's experience with the LSA. In addition, the portable handheld device 101 is provided with suitable program module and Apps to handle various commands from the LSA 100. All the learning Apps run on the portable hand held device, according to an embodiment. The portable handheld device 101 can be selected from the group of smart touch devices including but not limited to smart mobile phones, palmtop, iPhone, iPod Touch and iPad. Further, the portable handheld device 101 can include a touch screen. Accordingly, the LSA can be plugged with many types of ‘external and pluggable’ smart touch device to form a learning system.

According to an embodiment, the LSA 100 comprises of a suitably optimized keypad 102 including plurality of input keys for better child-friendly operability, a control circuit 103 to access communication between the LSA 100, and one or more LED light indications 104 for facilitating better usability of the LSA 100. The control circuit 103 includes keyboard matrix, micro-controller and identification & authentication hardware required to identify and authenticate with the device. Further, the firmware running on the micro-controller can process the key press events from the keypad and communicate further to the portable handheld device 101. However, firmware does not run any user learning application specific logic. Barring relatively small degree of application intelligence, the firmware primarily relays the key press event information to the Apps running on the device 101. Besides the child-friendly keypad 102 and the LED indications 104, the LSA can include one or more speakers 105 and an optional battery/power supply 106.

Therefore, the LSA can communicate with the device 101 such that when a child presses a particular key on the keypad of the LSA, it is taken as a user command and the same is effectively communicated to the operating system and/or Apps of the portable handheld device which follows the user command. In other words, a child can easily interact with the portable handheld device 101 via the pressing of the keys on the LSA 100. In an embodiment, the communication between the device 101 and the LSA 100 can be established via a cable connection between the device and LSA. In another embodiment, the communication between the device and LSA can be established via a wireless communication such as Wi-Fi, Bluetooth.

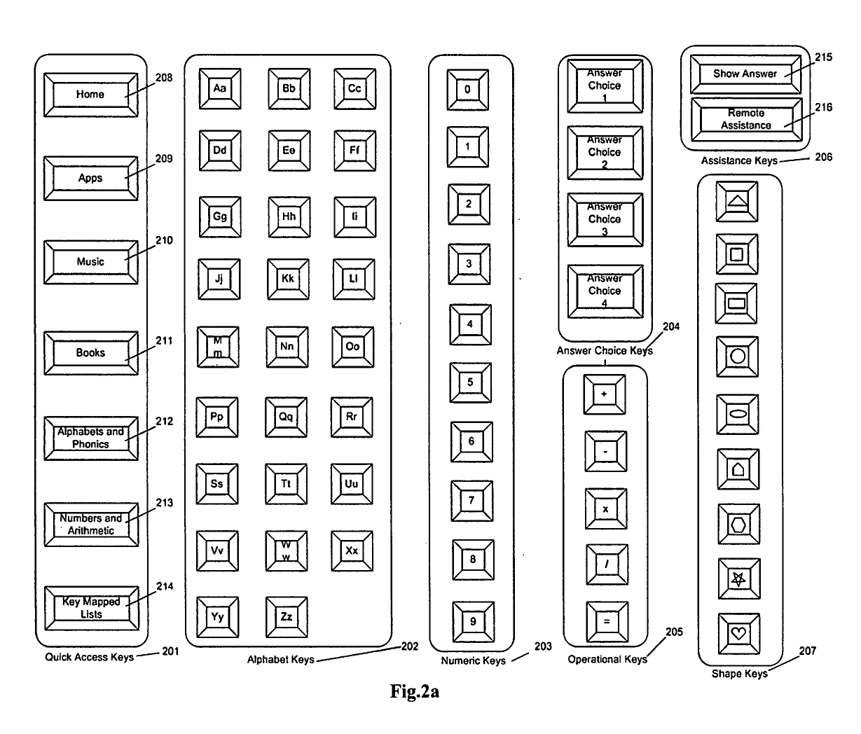

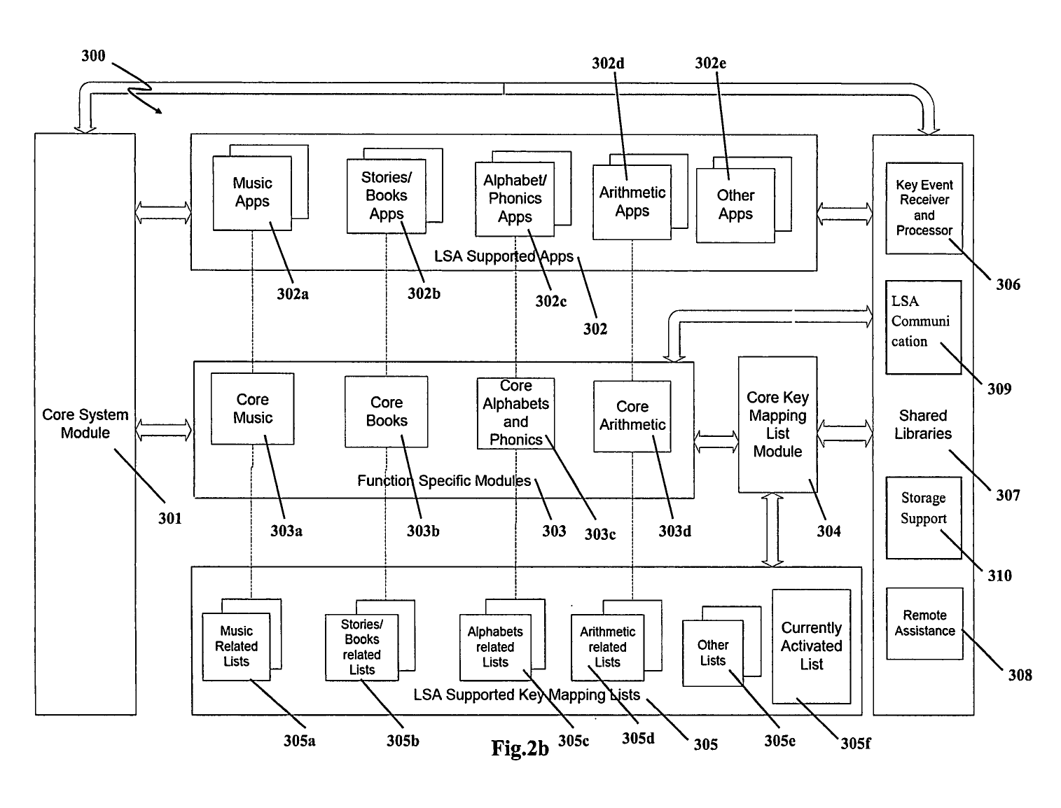

Now referring to FIG. 2, the keypad 102 provided in the LSA 100 is configured such that it is suitably optimized for children's ease-of-use, according to an embodiment. It should be noted that the present arrangement of the keys on the keypad 102 should be construed as an example and different variants of the arrangement can be used. In an embodiment, the keys on the keypad 102 includes plurality of quick access keys 201, alphabets 202, numeric keys 203, one or more answer choice keys 204, plurality of operational keys 205, one touch remote assistance key 206, plurality of shape keys 207 and plurality of navigational keys. The keypad 102 further includes a show answer key 215 and a remote assistance key 216.

According to an embodiment, the quick access keys includes a home key 208, an one touch Apps key 209, a music key 210, a books key 211, alphabets and phonics key 212, numbers and arithmetic key 213 and key mapped lists key 214. The alphabet keys 202 may comprise of the English alphabets and the numeric keys 203 including the numerals 0-9. In an embodiment, for quizzes and the like, one or more answer keys 204 are provided with choices to choose from. Further, the operational keys 205 are the basic mathematical function keys. Shape keys 207 are used for shape awareness in kids and puzzle games using provided shapes. Besides these keys, directional and selection keys can also be provided in the keypad for easier navigation.

According to an embodiment, software system architecture 300 for integrating LSA 100 with the portable handle held device 101 is illustrated. In an embodiment, the system 300 can include program modules and LSA supported Apps 302, wherein the program modules includes a core system module 301, function specific modules 303, core mapping list module 304 and shared libraries 307. The LSA supported Apps 302 can be configured to establish session with LSA 100 and being able to communicate with it in both directions. Further, the LSA supported Apps 302 can be categorized and specialized by their genre for instance music 302a, books 302b, alphabet/phonics 302c, arithmetic 302d and other specific apps 302e. Moreover, the LSA supported Apps 302 can use shared libraries 307 for common functionality such as accessory communication, storage, key event detection and processing etc. In an embodiment, the LSA supported Apps 302 are responsible to work with one or more core modules seamlessly.

According to an embodiment, the core system module 301 is an important module and can be configured to handle all the modules and Apps within the system 300. The core system module 301 is launched when the device 101 is plugged with the LSA 100, according to an embodiment. The core system module 301 is responsible for keeping up-to-date list of all available LSA supported Apps as well as installed LSA supported Apps. In further embodiment, the core system module 301 is also responsible for displaying all the Apps in response to ‘one touch Apps” key 209, and also responsible for launching other Apps and function specific core modules 303. In a further embodiment, the core system module 301 also coordinates and manages the common storage that needs to be maintained across the system 300.

In accordance with one embodiment, the function specific modules 303 can include but not limited to core music module 303a, core book module 303b, core alphabet and phonics module 303c, core arithmetic module 303d and other functional core modules as needed. One or more function specific modules 303 are launched by the core system module 301, when a user presses any of the respective function key in the LSA 100, according to an embodiment. For instance, when a user presses a book key in the LSA 100, the core book module 303b is launched accordingly. In an embodiment, the function specific modules 303 are responsible for homogenous presentation and execution of relevant area/function which includes music, arithmetic, alphabets, phonics and so on.

In another embodiment, the function specific modules 303 can communicate with core system module 301 to get the updated list of Apps specific to the selected function. According to an embodiment, the LSA supported key mapping list 305 is primarily a list of entries, where each entry specifies the action that should be taken by a delegated App, when a key as specified in the entry is pressed. In another embodiment, the function specific modules 303 can communicate with core key mapping list module 304 to get the key mappings lists 305 specific to the selected function. In another embodiment, the function specific modules 303 can be configured to process the content of the function specific key mapping lists 305. For example, core music module can identify and process the music related key mapping lists.

In an embodiment, the core key mapping list module 304 can be configured to coordinate for presentation, activation and storage of the key mapping lists 305. In a further embodiment, the core key mapping list module 304 can be configured to manage and keep the storage of the key mapping lists 305 up-to-date provided in the system as well as user created key mapping lists. In another embodiment, the core key mapping list module 304 can present the key mapping lists 305 in arranged manner to the user, when user presses ‘key mapping list’ key 214. In a further embodiment, the core key mapping list module 304 can store the currently selected list in common place so that all involved LSA Apps in processing of the selected list can have access to that list. Further, function specific modules 303 can query core key mapping list module 304 to provide the collection of the key mappings lists 305 related to their functions (for example, music, alphabets, books and so on).

According to an embodiment, the shared libraries 307 can include LSA accessory communication 309, key event receiver and processor 306, remote assistance 308, and LSA storage support 310. Accordingly, the LSA accessory communication library can establish session with LSA and send/receive data between App and LSA. And also it can encapsulate the device OS specific communication details from the App and provides it with higher level API (Application Programming Interface) for communication. The key event receiver and processor 306 library can interpret data received from LSA for key events and also process it to identify the details of key event. The remote assistance 308 library can provide remote assistance functionality when it is required by LSA supported App, according to an embodiment. Further, it can encapsulate underlying methods for establishing session between peer help provider's device 753 and the App, and communication between them. In an embodiment, the LSA storage support library can store data in persistent manner as required by LSA Apps and modules. Further, it can be adapted to various ways of storing data without the need of updating App. The examples of underlying storage could be device memory, network or cloud storage or even LSA storage.

In System 300, the LSA supported key mapping lists 305 are mainly viewed as the source of information to derive the action [for instance play nursery rhyme song or show picture] to execute when the key on LSA is pressed. Each entry in the key mapping list contains a pair of key identifier and associated action and/or content to display. In essence, each entry in key mapping list provides a processing directive with necessary information to LSA. When that list is selected by user as currently active list, LSA acts as per the processing directive, when a key is pressed. Accordingly, these lists 305 are primarily managed and presented to user by key mapping list module. Further, it can also be categorized by their functional area and can be presented to the user by the related functional modules 303.

In an advantageous embodiment, the LSA 100 includes a “one touch Apps” key 209 in the quick access key 201 to help a child to access the LSA adaptable Apps available in the portable handheld device 101 easily.

Functionality of the Apps Key:

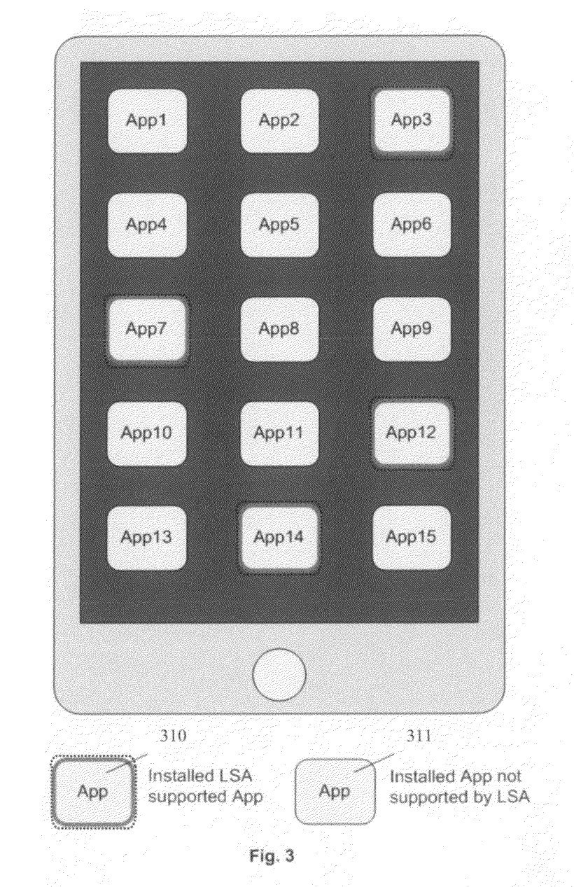

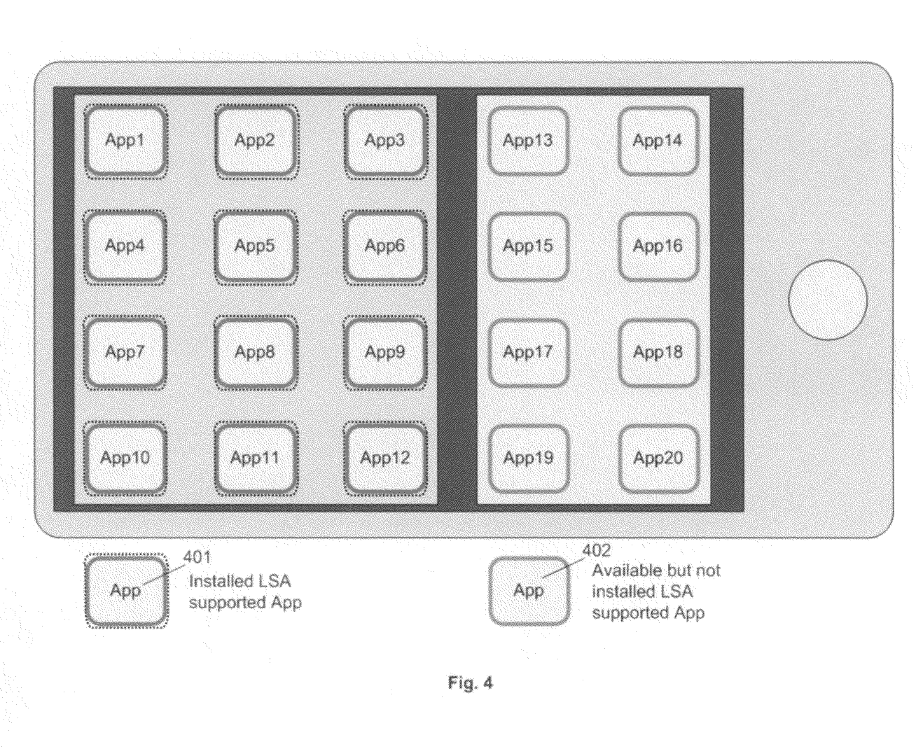

Since the portable handheld device 101 would be used by both parents and children, therefore, it is evident that there would be a lot of Apps in the portable handheld device 101; some meant for the grown-ups and some for the kids. Usually, in the screen of the device 101, these Apps would be displayed in a random manner, as illustrated in FIG. 3. The highlighted Apps shown in FIG. 3 are the installed LSA supported Apps 310 meant for children and the rest of the Apps 311 are for the grownups. For a kid to easily access the LSA supported Apps 310, he can press the Apps key 209 on the key panel, according to an embodiment. Once the Apps key 209 is pressed, the command is sent to the handheld device 101 to display the Apps which are supported by LSA, as illustrated in FIG. 4. Further, the ‘one touch App’ key 209 enables to display the installed LSA supported Apps 401 and the available Apps 402 on the device screen. This single touch key 209 can make easier for a child to browse through the LSA supported (or adapted) Apps available on the handheld device 101 without having to browse through other non-LSA Apps. Moreover, irrespective of the current screen that the user is interacting with, the pressing of the “Apps” key would display the list of LSA supported Apps on the device screen. The displayed list can include both the LSA supported Apps which are installed on the device and the LSA supported Apps which are available to download, but not yet installed on the device.

Working of the One-Touch “Apps” Key:

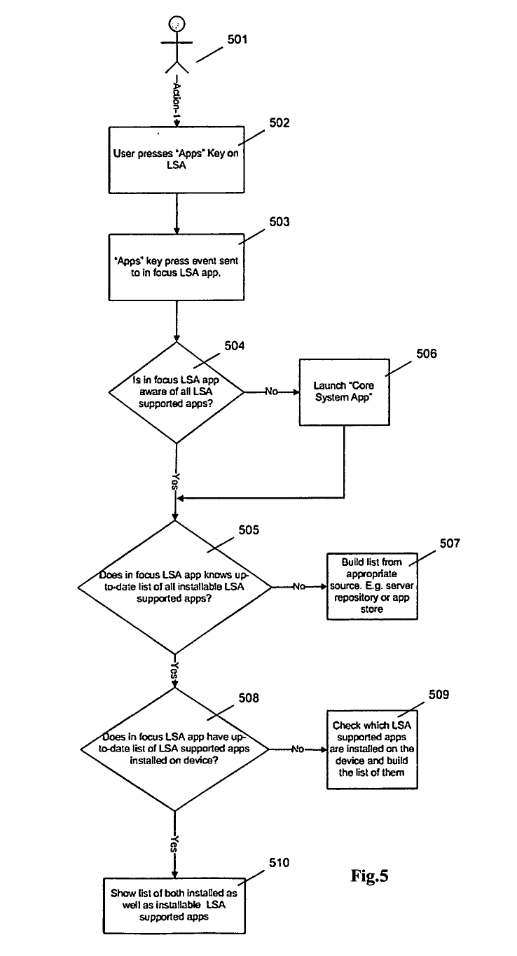

The “Apps” key 209 is one important key that is processed similarly in all LSA supported Apps 302. Now referring to FIG. 5, the various steps involved in the working of the one-touch Apps key 209 is illustrated. Accordingly, the user 501 can press an “Apps” key 502, to display LSA supported and installable Apps in the device screen. When LSA detects that “Apps” key is pressed, it checks if there is existing connection opened with any of the LSA supported App or not. If there is none, it requests device to launch App containing core system module 301. If the handheld device 101 has an opened connection with LSA 100, then the device is connected to an LSA supported App 302, according to an embodiment. In-focus App is denoted as the displayed App on the device that can also interact with the user. Typically device has many simultaneously running Apps, but only one App stays in-focus, while others are running in the background. In another embodiment, the in-focus App can request 506 device to launch its LSA core system module 301 when it is not aware of other LSA supported Apps, which are either installed on the device or available for installation on the device. After launching core system module 301 in the device 101, the in-focus LSA Apps can check 505 for the updated list of all installable LSA supported Apps 302 in the device 101, according to an embodiment. For in case, the in-focus LSA App does not know the up-to-date list of all the installable LSA supported Apps, then the information can be retrieved 507 either from a server repository or App store, however the exact mechanism can vary from device to device. At the same time, if the in-focus LSA App knows 505 the information of up-to-date list of all installable LSA apps, then the System can determine 508 whether the list of LSA supported Apps 302 which are installed on the portable handheld device 101 is up-to-date list or not. Further, if the device 101 does not have updated list, then it can check 509 which of the installable (or available) LSA supported Apps 302 are installed on the handheld device and make lists 305 of these Apps. Moreover, in case the device 101 has an up-to-date list 305 of installed LSA supported apps 401 then the same is displayed 510 on the device 101. Accordingly, a list of both installed LSA supported Apps 401 and available [but not yet installed in device] LSA supported apps 402 can be displayed 510, as shown in FIG. 4, while pressing the Apps key 209.

Once the lists of available Apps are displayed on the screen, the user can run an App by directly touching the App icon on the portable handheld device touch screen, according to an embodiment. In another embodiment, the application can be run by navigating using the directional keys provided on the keypad 102 of LSA 100. In yet another embodiment, the application can run by pressing any one of the mapped keys which are mapped to certain Apps. Accordingly, when the user uses the LSA keypad 102 and selects an App through a mapped key, a request to run that particular App is sent to the portable handheld device 101, and the device operating system [OS] would then open the particular App.

Functionality and Working of the Answer Key:

In an embodiment, an answer key 215 is provided in the keypad 102 for enabling a child to know the answer of a particular question asked in a quiz. Accordingly, the child can press the answer key 215 present in the LSA keypad 102 to know the answer. After pressing answer key 215, the LSA can send user command of “KeyPressed” with key identifier set to that of answer key 215. On receiving the user command, the recipient LSA supported App recognizes that the answer key 215 has been pressed. The App then displays the correct answer. In an embodiment, pressing of the answer key 215 would be ignored in case there is no quiz or question that needs to be answered. The App has autonomy on a particular method of displaying answer, which is not necessarily dictated by the system.

Functionality of the Home Key:

In an embodiment, a home key 208 is provided in keypad 102 for the user to navigate from one App to another. According to an embodiment, the home key 208 is a special access key located at a suitable place on the LSA keypad for easy recognition of the button by the kids with the help of which one can easily navigate through the various Apps and the home screen of an App. In a further embodiment, the App can also have home control button on its displayed screen. However, its functionality is limited to bringing the user to the home screen of the App, on the other hand, with the LSA's home key 208 the user can navigate from one App to another easily. Further, the home key 208 provides an easy way for the child to go to the perceived home screen of an in-focus App.

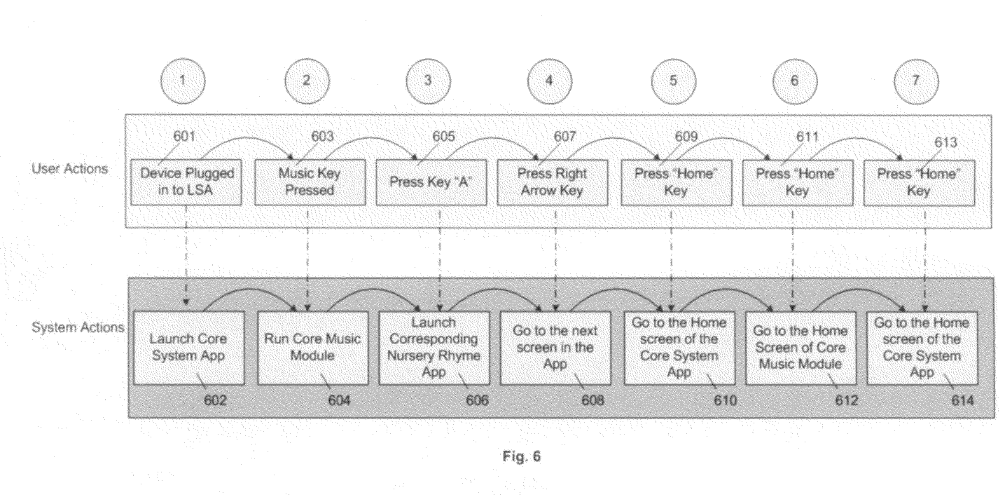

In an example, FIG. 6 illustrates system response/actions for various user actions on the Home Key provided in accessory. Accordingly, the LSA enables to launch 602 the core system app 301, when the portable handheld device 101 is plugged 601 with the LSA 100. Further, a core music module 303a is launched 604 and various music related lists 305a and Apps icons are shown on the device 101 screen as well as the default music list is activated, after pressing 603 the music function key 303a. Thereafter, the user can press 605 the key ‘A’ which can be mapped to any App for example a nursery rhyme App, wherein the System can launch 606 the nursery rhyme App immediately. In order to go 608 to the next screen in the nursery rhyme App, the user can press 607 the directional right key provided in keypad 102. Whenever he wishes to go back, each press of the home key 208 can enable to bring him to the last designated home screen in the context of navigation path, according to an embodiment. For example, the first home key press 609 may bring him back 610 to the home screen of nursery rhyme App. Thereafter, second immediate home key press 611 may force to switch 612 to another App i.e. core music module screen. Further, third immediate home key press 613 may force to switch 614 to home screen of core system App.

Working of the “Home” Key:

According to an embodiment, the context of a “Home” screen of the launcher App is passed on to the launched App, when one App [launcher App] launches another App [launched App]. Therefore, this context is used to return (navigate back) to the launcher App, when a user presses the home key 208. Accordingly a user can press the home key 208 on the LSA keypad to send the “KeyPressed” command along with the key identifier set to that of the home key 208. As soon as the App receives and recognizes that the home key 208 is pressed, the App can replace the displayed screen to its interpretation of perceived home screen from its current state in the App, according to an embodiment. However, the pressing of the home key 208 may be ignored when there can be no further interpretation of perceived home from the App's current state.

Functionality of the Remote Assistance Key:

According to an embodiment, a remote assistance key 216 is provided in LSA keypad 102 for facilitating a child for any guidance or help as and when needed. Accordingly, it makes use of the wireless, internet and the multi-media capabilities offered by portable handheld device to help a child get instant help/guidance.

Working of the One Touch “Remote Assistance” Key:

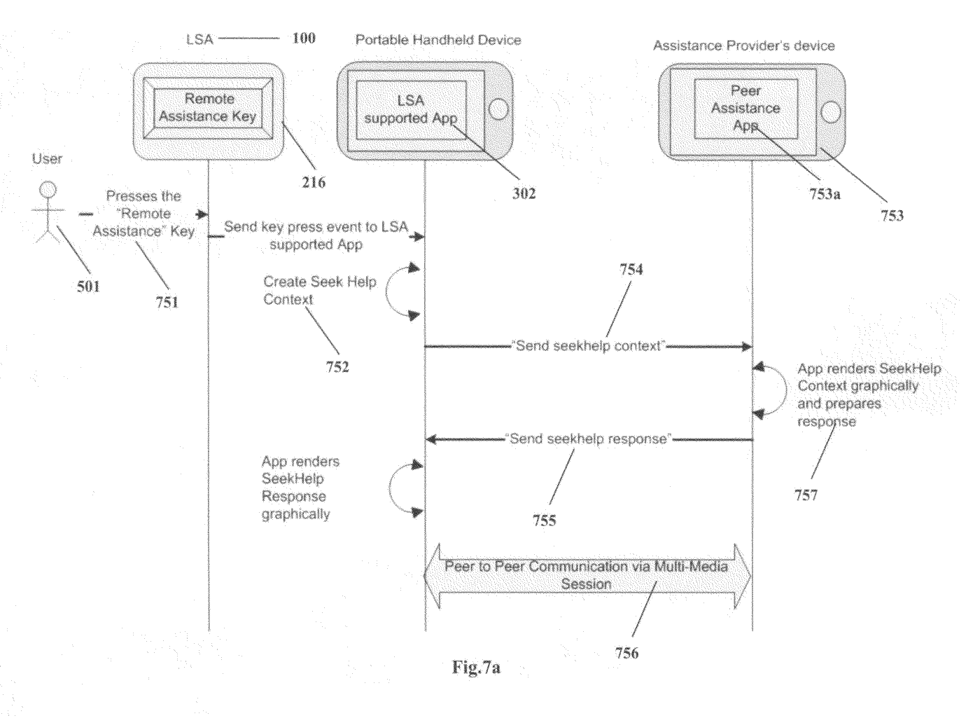

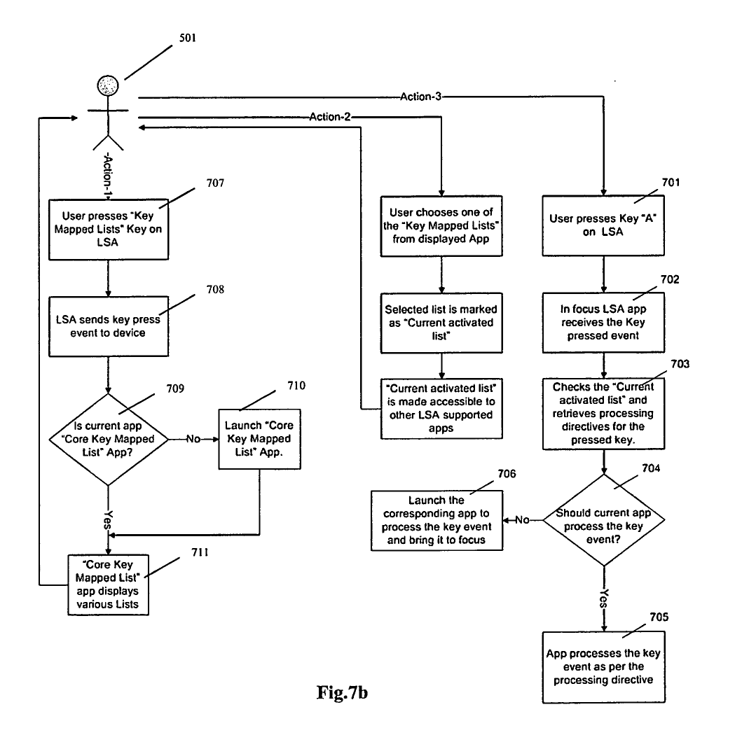

FIG. 7a illustrates working principle of one touch remote assistance key 216, in accordance with an embodiment. Whenever the remote assistance key 216 is pressed 751, the App receives the user command and recognizes that the remote assistance key 216 has been pressed. In one embodiment, the App can create 752 a relevant “SeekHelp” context by gathering the current state of the App and child's interaction with it.

Accordingly, the “SeekHelp” context can collect as much intelligence and information as possible from the current App. It can include the relevant state of the App required to reproduce a closely matched audio visual experience on Assistance Provider's device 753. The relevant state information of App can include but not limited to relevant text, images, audio, video data etc. The context may also include other important and effective pieces of information, e.g. time spent by the kid on the current problem, number and variations of answers tried by kids for the given question etc. The nature and amount of information that is included in the SeekHelp context may vary from App to App. Further, the “SeekHelp” context can include text, XML, Audio, Video or any such combination.

In an embodiment, the App 302 can establish connection with the “Peer Assistance App” 753a running on the assistance provider's device 753. Further, the App 302 can send 754 the SeekHelp context to the assistance provider's device 753. In an embodiment, the device 101 plugged in LSA 100 and the assistance provider's device 753 may be wirelessly connected 756 to each other.

In one embodiment, the user 501 of LSA 100 can configure the list of probable assistance providers. Further, the user 501 can also prioritize the providers in this list. In a further embodiment, the user 501 may decide to sequentially connect to the listed assistant providers in order of their set priorities, till one of the assistant providers accept the connection request. In yet another embodiment, user may also decide to send simultaneous connection requests to all listed assistant providers and start session with the assistant provider, who first accepts the connection.

According to an embodiment, the peer assistance Apps 753a can include necessary logic and provisions, to display “SeekHelp” context that it has received. The necessary information in one or many of the suitable format for example text, images, audio, visual etc is organized in “SeekHelp” context. In one embodiment, the SeekHelp context is presented on peer assistance App 753 in a way effective to enable assistance provider to respond 757 appropriately and effectively.

The user of the peer assistance App 753a can choose to respond 757 to the received SeekHelp context, according to an embodiment. The necessary information of his response in one or many of the suitable format for example text, images, audio, visual etc is organized in “SeekHelp” response 757. Further, the SeekHelp response is sent back 755 to the App which has requested the assistance. In another embodiment, the App 753a may choose to skip the rendering of the “SeekHelp” response on the App screen, for example, if the child has already moved on to the next question. However, the responses may be stored for future reference.

In one embodiment, the user can also choose to record his message to assistance provider. The App can record the user's voice along with optional video. The recorded file can become part of the SeekHelp context and can sent to assistant provider.

In one embodiment, the App can open a multi-media including audio/video communication channel 756 with the peer assistance App 753a running on the assistance provider's device 753. To this end, third party APIs may be used to embed support of media rich conversation from one App to another.

In one embodiment, when user presses the remote assistance key 216, he may opt to perform either a) an exchange of SeekHelp context and response or b) also the establishment of multimedia communication channel with assistance provider or both.

In an advantageous embodiment of the present invention, quick access keys 201 are present in the keypad to access to specific functions like music 210, story 211, and arithmetic 213 and so on. To understand the function of these keys better, the working principle of the music mode key 210, book mode key 211 and the alphabet and phonics mode key 213 are described below.

Music Mode Key:

According to an embodiment, when the user presses the music mode key 210, the device 101 can launch the core music module 303a. Further, the core music module 303a can by activate default key mapping list 305a that may be mapped to keys in the LSA to nursery rhyme App and/or nursery rhyme song audio/video, music instruments sound, piano keys. In addition, the core music module 303a can facilitate easy access to other music related Apps and also music related lists (for example video on youtube, audio songs from iTunes store and other locations, music instruments sound). As soon as the core music module is launched, most of the keys of the LSA 100 mapped to some audio file, for example a nursery rhyme or a piano keys can be easily accessed.

Working of the “Core Music” Module:

In an embodiment the core music module 303a includes “Essential” mode and “Extended” mode. However, to make the interface simpler, these modes are not shown separately to the user. In an embodiment, in the Essential mode, the keys on the LSA are mapped such that Alphabet keys might be mapped to the Nursery Rhyme App containing any number of nursery rhymes wherein pressing an alphabet key would launch a nursery rhyme, the numeric keys may play the piano key sounds and so on. In one embodiment, pressing a key might either launch a new nursery rhyme App or if the App is already running and then run the interactive show for the nursery rhyme that is mapped to the corresponding key.

In the “Extended” Music Mode, a list of music related data content may be displayed and the user can choose to select an entire list or a particular item (App). If the user selects a list, each individual item on the list would be mapped to its assigned key on the keypad. In an embodiment, new lists can also be created by using the “List Configuration Utility”. Usually, the lists are played in context of the core music module; hence pressing the home key would display the core music module screen. The user can then navigate through other lists and select the one he wishes to be mapped to a particular key. Therefore, this method allows a child to correlate with the concept of various lists and provides a simpler key sequence to work with them.

Book Mode Key:

The book mode key 211 works similar to the music mode key 210 except the nature and presentation of the content would differ. The book can include any reading material used for reading children's learning of language. According to an embodiment, when the book mode key is pressed, the device can launch the LSA supported core books module 303b which in turn activates the default book list. The book list can include books in any format; the only main requirement being that the format should be supported by the device's OS. Therefore, it can be audio, non-audio, video books, accessed from the device's supported online stores or from any other supported online stores/book provider. These lists displayed from the core books module 303b can be browsed using the directional keys or by touch. In “Essentials” mode, most of the LSA keys are mapped to the default book list. Moreover, there is no restriction placed on how many book can be contained in one App. So books can be contained across multiple LSA supported Apps and in non-equal numbers among the Apps. This can be achieved through mapping and division of the keys. For example, one App with 10 stories can be mapped to the keys A-J and another App with just one story can be mapped to the key K and so on. This embodiment of the present invention of allocating the mapping of multiple keys to an App solves the problem of either creating one App for a single entity (e.g. interactive book, music audio, video, pictures etc) or combining all the files in a single App.

Alphabets and Phonics Mode:

The alphabet and phonic module 303c can include two modes: “Essential” and “Extended”. The “Essential Mode” of the Alphabets and Phonics Mode would display a list organized as per category (For e.g. Animals, Birds, Sports etc.). Each item in any of this lists, would be mapped to a corresponding key of the accessory, for example, pressing the key A would show a picture of an Apple along with an audio file containing its pronunciation and spelling. Unlike traditional educational toy which shows/spells a picture/word are fixed for a particular fixed alphabet keys, in an embodiment of the present invention, any number of alphabet lists can be created for different categories and mapped to the same alphabet keys. When core alphabet and phonics mode is launched, a default key mapped list is usually displayed. Advantageously, more alphabet lists can be added or the available one can be changed to help the child learn newer words, according to an embodiment. Other non-alphabet keys can also be mapped to various types of phonics, vowels and their usage. The “Extended” mode would display the various Apps related to alphabets and phonics.

In an embodiment of the present invention, a key mapped list includes more than one item, wherein each item includes a processing directive and the key identifier on LSA. The processing directive includes specific information about an action that App can take (for example run another App, or run one of the modules from the current App, play song from device's storage, play video from internet etc.). When a key is pressed on LSA and App receives a “Key Pressed” event from LSA, App acts as per the processing directive contained in the list for the pressed key. This method of mapping individual keys to corresponding processing directives and containing such mapped key entries in a list provides an effective mechanism, which can provide the ease-of-use while unlocking the treasures of content available on the device and also on the internet (accessed via device). Mapping of the keys makes navigation and content exploration much easier for a child. The method of delegating key pressed events to designated App to solve the above problem is elaborated below.

Creation of the Key Mapped List:

A Key mapped list includes 3 elements:
a) Mapped key name or Identifier—for example, Key Z (Identifier 26)
b) Information of an App to process key press event—for example, unique App Identifier as recognized by Device operating system and/or App name;
(c) Context—Context includes the information about processing directive. It makes an App aware of what action should be taken by it, when a key is pressed. For example, play a song available at a link on a website.
   For the user, the intrinsic detail of the process may be hidden and the context entry would be simplified to provide ease-of-use for him to create a mapped list.

Activating the Key Mapped List:

According to an embodiment, the user can browse through the available key mapped lists by pressing key mapped list function key 214. Further, it can display all the available lists on the screen. In another embodiment, user can also press category specific function keys 303 to browse through category specific lists 305 only. When he presses 707 the ‘key mapped list’ key 214 on the LSA keypad 102, the LSA can sends 708 the key press event to the device 101. For in case, the current App 709 is the core key mapped lists App 304, then the same would display 711 the various lists on the device 101. If the current App is not the core key mapped lists App 304, then it launches 710 the same 304 and then displays 711 the various lists on the device.

In another embodiment, when LSA displays 711 the various key mapped lists, user can select one of the displayed lists. The selected list is kept in common storage and made accessible to all LSA supported Apps running on the device. It is also marked as the currently activated list. All LSA supported Apps running on the device refers to this selected list to find the processing directive, if and when they receive a Key Press Event from LSA.

When a user selects a particular list, sometimes it may be required that the content of the list be accessible by more than one LSA supported App. So the selected list can be placed in common storage, which can be accessed by relevant LSA Supported Apps. The nature of common storage can be OS Specific (for example keychain storage in iOS, Shared File Read/Write or Network Cloud etc). However, if the device OS cannot support in offering a viable common storage method to share data across Apps, LSA can use its memory space to store currently selected list, according to an embodiment.

In another embodiment, if any common storage method (facilitated by OS, Network Storage or LSA Storage) cannot be found or used for any reason, the entire list can be passed from one App to another. The portable handheld device OS typically provides a way to invoke another App from the currently displayed App. The exact nature of Peer App invocation method may be OS dependent. This method typically has provision to pass data and argument from current App to launching App.

In an embodiment, the access to currently activated list helps an in-focus LSA supported App to quickly determine if the received key press event should be processed by it or should the event be further delegated to other App. Each item in the list contents the App Name and/or Unique App Identifier.

Handling Key Press Event:

As illustrated in FIG. 7, once the key mapped list 305 is activated and the user can presses 701 one of the keys, and the current in-focus App receives 702 the key press event. Further, the App would check 703 the current activated list and get the processing directive for the key. The processing directive contains the vital information about an App responsible to process the key event. Further current App checks 704 if it should process the event key or not. In case to process the key event, then the current App process 705 the key event as per the processing directive, otherwise it can launch 706 the corresponding app to process the key event and bring it to focus.

Delegation of Key Press Event to Other App:

In case the in-focus App has to delegate the processing of the key to another App, it can use the OS supported Peer App invocation method, according to an embodiment. This method also has provision for specifying arguments. This provision can be used to pass the necessary information (key press event, home screen navigation etc) to the invoked App. When the Peer App receives the re-delegated key press event, it will take necessary action to process the key press event.

As seen from the above, a single key can initiate different actions and show different set of information of a particular function because of the mapping, in accordance with an embodiment. For example, in the Alphabet and Phoenix mode, each key ‘A’ to ‘Z’ may show corresponding picture as per the configuration. These keys can also be mapped to newer lists to improve a child's knowledge. For example, for one week, names of different fruits from A-Z can be mapped; for the next week, names of different birds from A-Z can be mapped and so on. In the same way, music, photos, video files as well as internet content can be mapped. In essence, key mapping lists and the method of mapping keys to the lists, provides effective way to bring rich and varied content to the kids that they can access and explore very easily. Further, it also provides effective way for parents to create or import knowledge specific lists and periodically introduce to their kids.

In another embodiment, the system can track and analyze children's learning progress and/or score and automatically change the default key mapped lists for each of the supported functions such as Alphabet and Phonics, Music, Books, Arithmetic and so on. Further, the list can also be changed periodically by the software system. Therefore, this smart update mechanism of key mapped list would be advantageous for kids to constantly receive new and varied set of information based on the evaluated criterions.

In an embodiment of the present invention, provision is made to configure the various LED (Light Emitting Diode) lights present in the LSA for customized LED “expressions”. There are various purposes of LED present in the LSA, according to an embodiment. A communication ready indication LEDs would be lit, when power is available to the LSA and when it is ready to be operated. There are also LEDs for answer choices and the LSA can prompt the user to answer a specific question by lighting up the LEDs. There are also other LEDs that lit up depending on the situation, for example, an LED for a wrong answer or corresponding to a clock ticking for answering the question in time.

Moreover, different Apps can choose their own LED “expressions” and sound. For example, one App can choose to blink first LED light 2 times when the answer entered is correct and second LEDs 4 times when the answer is wrong. The other App can choose to blink the second LED 4 times when the answer is correct and first LED 3 times when the answer is wrong, according to an embodiment. So even if the intent of action (e.g. wrong answer indication) may be same for each App, they can choose their own way of expressing it on LSA.

In one embodiment of the present invention, wherein LED “expressions” can be configured makes it a far advantageous than traditional educational toys that comes with a fixed set of LED “expressions”. In an embodiment of the present invention, different kind of expressions can be used in different Apps. This method allows the varying experience for kids while interacting with LSA. It also helps App Developers to customize the expressions on LSA to suit their type of applications.

In one embodiment, an App can overcome the challenge of keeping up with the revisions of LSA as well as new types of LSA. The challenge is primarily due to possibility that each revision of the same kind or new kinds of LSA can have potentially have different arrangements of resources (e.g. number of LEDs or type of LEDs etc). In one embodiment, LSA publishes its “Accessory Resource Scheme” to LSA supported Apps. Accessory resource scheme may contain all the intrinsic details (e.g. type of resource, method to access, limitations) of resources (e.g. LEDs, Speaker configuration, keys) available on LSA and directly/indirectly accessible to external entities such App. By virtue of “Accessory Resource Scheme”, the App becomes aware of what resources are available on the Accessory and which can be used and within what limits. Such new or updated Accessory Resource Schemes does not require changing or upgrading the App. Also, no source code changes are required. In another embodiment, App can define its own “Accessory Expression Scheme”, which details the LED related (and also other possible resources such as speaker, microphone on LSA) expressions that App can request LSA to perform, albeit within the limits of “Accessory Resource Scheme”. “Accessory Expression Scheme” defines the pattern/expression (e.g. blinking of LEDs) on LSA, when a particular event occurs on the App (e.g. detection of wrong answer). Since each App will have its own “Accessory Expression Scheme”, this gives an advantage of using various Apps with different “expressions” on one LSA. Also, multiple LSAs can be supported by an App as long as it has been provided with both “Accessory Resource Scheme” and “Accessory Expression Scheme” for the supported LSAs. Moreover, LSAs can go through revisions and publish their revised “Accessory Resource Scheme” to Apps to maintain compatibility.

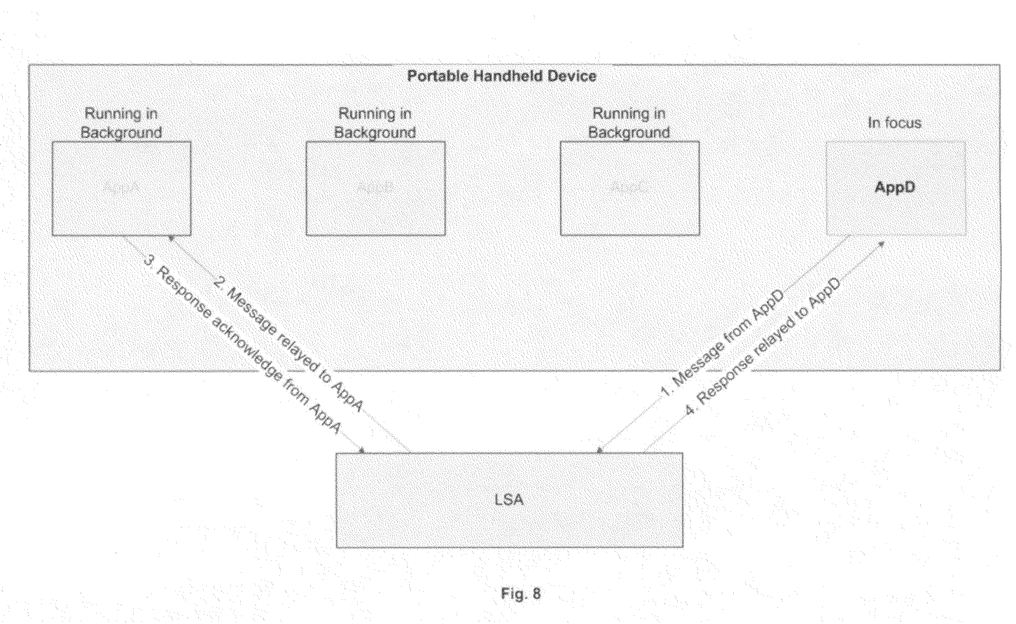

In another embodiment, the LSA supports App to App communication via LSA. As illustrated in FIG. 8, in this method, LSA can act as a messenger between the Apps. When the LSA is communicating with one App (App D), it takes the message from it to be given to another App (App A). Once message is relayed to App A, the response acknowledgement from App A is relayed to App D. Depending on whether the handheld device 101 allows the LSA 100 to be connected to multiple Apps simultaneously or not, the LSA would either instantly send the message to the other App which is running or store the message and wait for the other App to connect to accessory, before delivering it. This method of using LSA as a messenger between two Apps is a useful embodiment that can be also applied to keeping system wide scores while playing quizzes and the like.

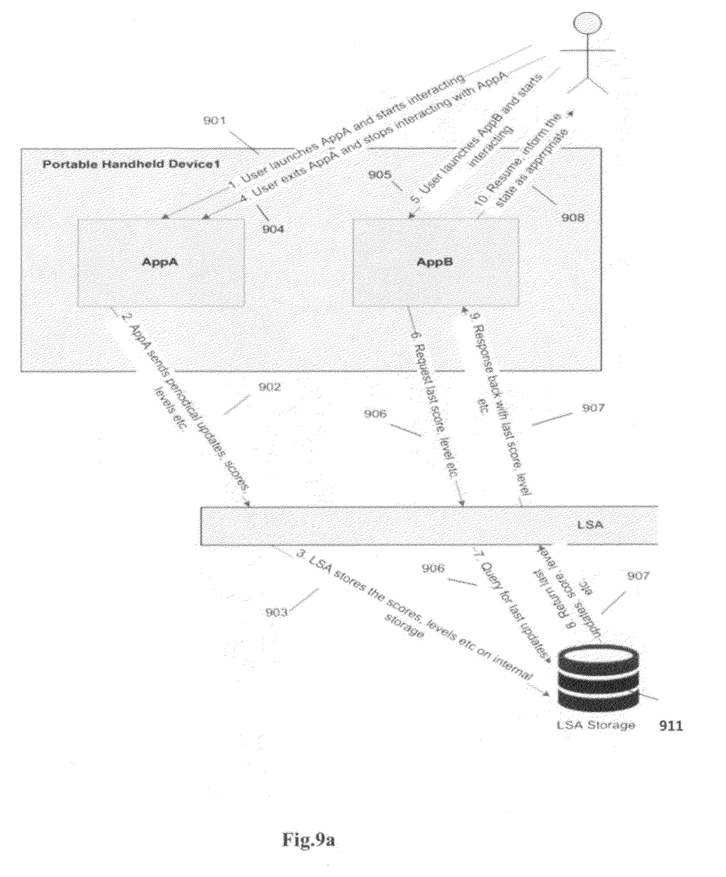

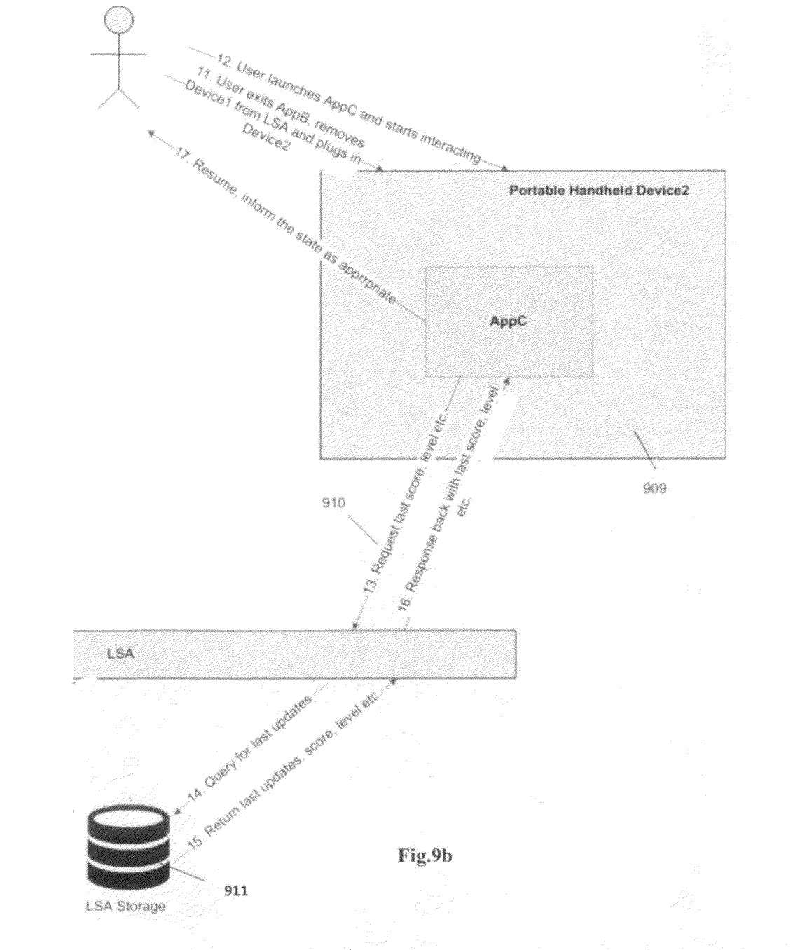

In another embodiment, the LSA facilitates a method to keep information collected at user and system level, but across multiple devices and multiple Apps. In a typical usage of LSA, from time to time user may plug in various numbers of portable handheld devices in LSA and interact with different types of Apps on those devices. This interaction may result in important system wide parameters (e.g. total time spent in interacting with learning Apps, score, progression of the skills etc) for that user, which needs to be tracked and stored at central place. As illustrated in FIG. 9, a user can launch App A 901 and start interacting; according to an embodiment. App A can send periodical updates 902 to the LSA regarding the levels, point accumulated etc. This information can be stored in the LSA memory 903. As and when the user stops interacting with App A 904 and launches App B 905, App B would request 906 the LSA of the updates and the LSA would respond 907 with the latest updates stored in its internal memory, and App B can resume the program 908. App B can also send its periodical updates to LSA regarding levels, points accumulated etc. This type of system wide information update management can also be applied when a user changes the handheld device. Since the information is stored in LSA's internal memory, as and when App C of a different handheld device 909 is plugged to the LSA 100, the App C can request for the updates 910 and resume the activity.

In another preferred embodiment, one portable handheld device 101 can be used with more than one LSA and used to synchronize the information stored in one LSA with another LSA. In a situation when teacher wants the entire student's LSA to maintain parity or when there needs to be parity between the LSA used at school and home by a kid, the App of the first LSA can send a “Retrieve Context” message to the LSA and retrieve the context. This context may be stored either on a device or on network storage, accessible to the App. When the handheld device from the first LSA is placed in another LSA, the App first can retrieve the stored context either from a device or network storage and can send the “Download Context” command with previously stored context from the App and the context would be downloaded to the second LSA. The context can be either automatically activated on LSA or via a separate “ActivateContext” command would activate the context on that LSA. This method assists in effective synchronization and progression of user experience involving more than one LSA, while plugging the same device in multiple LSAs.

In yet another important embodiment, LSA facilitates a seamless and customized user experience for an App, with which user can interact on different devices but with same LSA. In a situation, where in class room kid interacts with App A on the portable handheld device provided by the school but with his own LSA. As an example, he can interact with App A in its learning mode. In the class room, App A running on a school's portable handheld device can store the homework for the kid. The homework information can be stored on LSA. Then at home, kid interacts with same App A but on his parent's portable handheld device. App A would retrieve the context from LSA, which would guide him to display home work (or follow-up work). Accordingly, this method provides a powerful mechanism of customizing, synchronizing and influencing the App's behavior when it is run across multiple devices, yet involving the same LSA. This method assists in effective synchronization and progression of user experience involving one LSA, which is plugged in different devices from time to time.

Exemplary Working of the LSA:

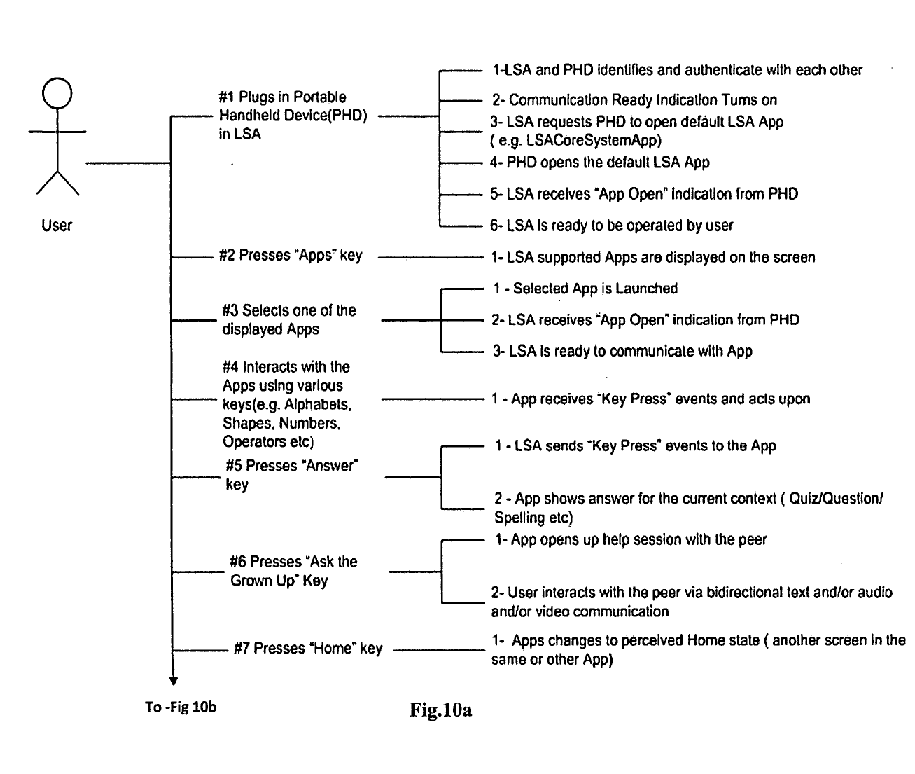

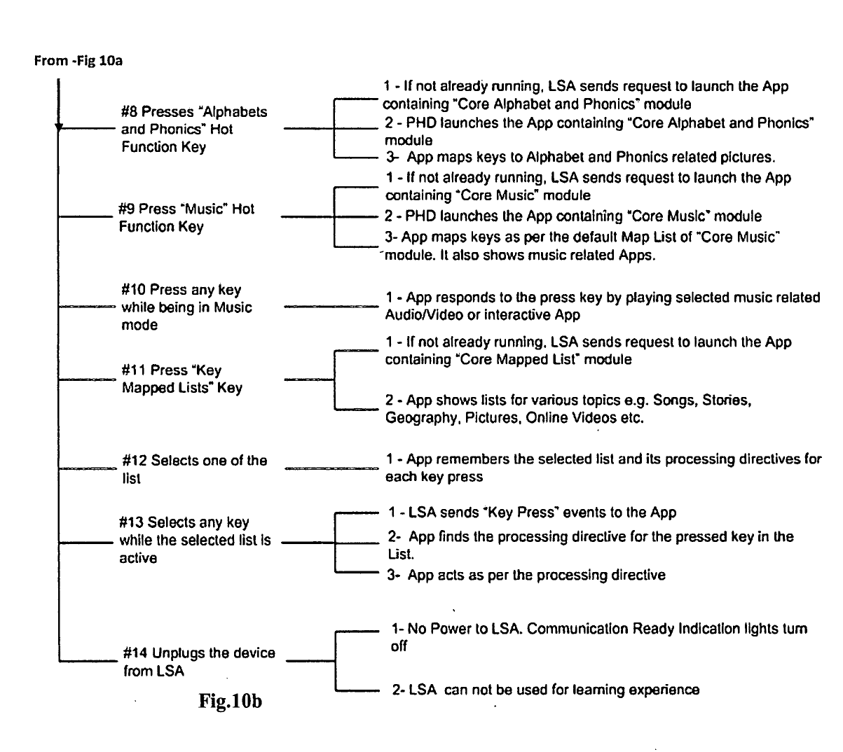

As illustrated in FIG. 10, the first step is to plug the portable handheld device in the LSA, according to an embodiment. The two entities (i.e. LSA and Portable Handheld Device) would identify and authenticate each other and the LED Communication Light would light up. Then, the LSA would request the device to start the CoreSystem App, which when started by the device and the same action recognized by the LSA, the LSA would be ready to be operated by the user.

When the user presses the “Apps” key, the LSA supported Apps (both installed and not yet installed) would be displayed on the device. The user then selects any of the displayed Apps and the same is launched. In this step, LSA receives “App Open” indication from device and is ready to communicate with the launched App.

With the help of various keys on the keypad of the LSA, the user can interact with the Apps. During this step, the App receives “Key Press” commands from the LSA and acts upon the command.

In a situation when the user is playing a quiz in an App and wants to know the answer of a particular question, the user can press the “Show Answer” key, upon which the LSA sends the “KeyPress” command to the App and the App displays the answer of the currently displayed quiz or question.

In any situation when a child needs help, he can press the “Ask the Grown Up/Help”(also referred as “Remote Assistance”) key that can open a session with a peer and the user can interact with the peer through text, video, audio or any other communication modes to seek assistance.

Whenever the user presses the “Home” key, the Apps can change to the perceived Home state. The perceived Home state could be either a Home screen of the same App or some other screen in a different App.

Whenever the user presses the “Alphabets and Phonics” key, LSA can send request to launch the App containing “Core Alphabets and Phonics” Module, if it is not already running and once launched by the device, each keys on the LSA keypad can be pressed to display different Alphabets and Phonics related content and/or launch Apps.

Again, when the user presses the “Music” key, the App containing “Core Music module” is launched, if it is not already running and the App keys mapped to a music related file or App, when pressed, would be launched.

For Mapping of Keys, the user needs to press the “Key Mapped Lists” key, which launches the App containing “Core Mapped List Module” on the device (if it is not already running) which shows the various categories of data content available. For mapping, the user needs to select one of the lists. The App memorizes the selected list and its processing directives for each key press. Each key pressed while the selected list is active would make the LSA send “Key Press” events to the App. The App finds the processing directive for the pressed key in the list and thereafter acts as per the processing directive.

Once the device is unplugged, the LED Light is turned off. LSA is no more communicable with portable handheld device. It cannot be used for any learning activities on its own.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A learning system accessory [LSA] for kid's learning purposes comprises of:
a keypad includes plurality of keys;
a control circuit to access communication between the learning system accessory and a portable handheld device; and
one or more LED light indicators for facilitating better usability of the LSA;
wherein the learning system accessory is configured to integrate with the portable handheld device, wherein the keypad comprises of alphabets keys, at least a show answer key, numeric keys, plurality of answer choice keys, plurality of operational keys and one or more shape keys quick access keys and at least a touch remote assistance key.

2. The learning system accessory [LSA] of claim 1 further comprises of one or more speakers, amplification circuit to amplify the sounds, and a battery for power supply.

3. The learning system accessory [LSA] of claim 1, wherein said portable handheld device is configured with a software system to handle various commands from the LSA.

4. The learning system accessory [LSA] of claim 2, wherein said portable handheld device communicates with said LSA through wired cable.

5. The learning system accessory of [LSA] claim 2, wherein said portable handheld device communicates with said LSA through wireless communication means.

6. The learning system accessory [LSA] of claim 1, wherein control circuit comprises of keyboard matrix, micro-controller and identification & authentication hardware.

7. The learning system accessory [LSA] of claim 1, wherein said quick access keys comprises of home key, one touch Apps key and key mapped lists key.

8. The learning system accessory [LSA] of claim 7, wherein said one touch Apps key enables to segregate and display LSA supported Apps from the other Apps available on said portable handheld device.

9. The learning system accessory [LSA] of claim 7, wherein pressing said one touch Apps key enables the said LSA to send user command to said portable handheld device to launch the Apps to display supported apps by said accessory.

10. The learning system accessory [LSA] of claim 7, wherein said touch remote assistance key enables to connect the portable handheld communication with LSA to assistant provider's portable handheld device.

11. The learning system accessory [LSA] of claim 10, wherein pressing said touch remote assistance key enables the in-focus LSA supported App to create a relevant “SeekHelp” context by gathering its current state and user's interaction with it.

12. The learning system accessory [LSA] of claim 11, wherein said “SeekHelp” context can collect intelligence, information, current state of the App and valuable parameters from the in-focus LSA App.

13. The learning system accessory [LSA] of claim 11, wherein said “SeekHelp” context can include text, XML, Audio, Video or any such combination.

14. The learning system accessory [LSA] of claim 7, wherein said home key is located at a suitable place on the said keypad for easy recognition of the button by the kids and enables to easily navigate through the various Apps and the home screen of an App.

15. The learning system accessory [LSA] of claim 14, wherein pressing said home key enables the LSA to send “KeyPressed” command to portable handheld device along with key identifier set to that of the home key, wherein the home key for is provided in keypad 102 for the user to navigate from one App to another.

16. The learning system accessory [LSA] of claim 15, wherein each press of said home key can enable to bring the user/kid to the last designated home screen in the context of navigation path.

17. The learning system accessory [LSA] of claim 7, wherein said “key mapped lists” key enables the user to browse through the available key mapped lists in the portable handheld device and select the list, wherein multiple items of the selected list are mapped to the keys on LSA.

18. The learning system accessory [LSA] of claim 17, wherein pressing key mapped lists key enables the LSA to send key press event to said portable handheld device, wherein in-focus App launches core key mapping lists module to display the various key mapped lists on the device.

19. The learning system accessory [LSA] of claim 18, wherein said user can select a list to activate the selected list, wherein the activated list can be stored in common storage to be accessed by relevant LSA supported Apps, wherein the activated list(s) is made user to interpret the key press events in the context of activated list.

20. The learning system accessory [LSA] of claim 18, wherein each item of key mapped lists contains key identifier, Identifier of the App responsible for processing the Key Press event of identified key and processing directive which contains the information about the action that App should take and the context that App should use to perform the action.

21. The learning system accessory [LSA] of claim 20, pressing any of said key mapped list key enables to send the event to the App, which interpret the key press event in the context of activated list and take specified action.

22. The learning system accessory [LSA] of claim 3, wherein said system can track children's learning progress and can automatically change default key mapped lists of quick access keys.

23. The learning system accessory [LSA] of claim 22, wherein said change of default key mapped lists is for each of the supported function including alphabet and phonics, music, books, and arithmetic.

24. The learning system accessory [LSA] of claim 22, wherein said list can also be changed periodically.

25. The learning system accessory [LSA] of claim 1, wherein said answer key enable the user to know the answer of a particular question asked in a quiz.

26. The learning system accessory [LSA] of claim 25, wherein pressing said answer key enables the LSA to send user command of “KeyPressed” with key identifier set to that of answer key, wherein in-focus App displays the correct answer.

27. The learning system accessory [LSA] of claim 1, wherein said answer choice keys enables the user to quickly enter one of the answers for the question.

28. The learning system accessory [LSA] of claim 26, wherein LED present on the answer choice keys can flash to indicate the user for entering the answer using one of the answer choice keys.

29. The learning system accessory [LSA] of claim 2, wherein the LEDs are operated as per the customized LED expressions in the App.

30. The learning system accessory [LSA] of claim 29, wherein said LED expressions can be varied for various Apps.

31. The learning system accessory [LSA] of claim 1, wherein communication between Apps to Apps can be supported via said LSA.

32. The learning system accessory [LSA] of claim 3, wherein said software system is configured to plug said LSA to one or more portable handheld devices and to interact with different types of Apps on those devices and also store the context in the device or LSA storage.

33. The learning system accessory [LSA] of claim 3, wherein said software system is configured to plug said portable handheld device with one or more LSA and to synchronize the information stored in one LSA with another LSA.

34. The learning system accessory [LSA] of claim 33, wherein said portable handheld device can be plugged with one or more LSA at different time instances.

35. The learning system accessory [LSA] of claim 3, wherein said software system comprises of
core system module responsible for keeping up-to-date list of all available LSA supported Apps as well as installed LSA Apps;
function specific modules responsible for homogenous presentation and execution of relevant function;
core key mapping list modules responsible for presentation, activation and storage of the key mapping lists;
shared libraries responsible for establishing session and to sending/receiving data between App and LSA; and
LSA supported Apps configured to establishing session with LSA and interact with other LSA supported Apps and modules, and also to communicate with it in both directions.

36. The software system of claim 35, wherein said core system module further responsible for displaying all the Apps in response to ‘One touch Apps” key; and
coordinating and managing the common storage that needs to be maintained across the system.

37. The software system of claim 35, wherein said function specific modules comprises of core music module, core book module, core alphabet and phonics module and core arithmetic module.

38. The software system of claim 35, wherein said function specific modules can communicate with core system module to get the update list of their function related Apps and core key mapping list module to get the key mappings lists specific to their function.

39. The software system of claim 35, wherein said key mapping list module can be configured to manage and keep storage of key mapping lists up-to-date provided in the system as well as user created key mapping lists, wherein the user is allowed to create key mapping lists.

40. The software system of claim 35, wherein said key mapping list module can present the key mapping lists in arranged manner to the user, when user presses ‘key mapping list’ key.

41. The software system of claim 35, wherein said key mapping list module can store the currently selected list in common place so that all involved LSA Apps in processing of the selected list can have access to that list.

42. The software system of claim 35, wherein said shared libraries include LSA accessory communication, key event receiver and processor, remote assistance, and LSA storage support.
